(19) United States
(12) Patent Application Publication
(10) Pub. No.: US 2005/0099384 A1
(43) Pub. Date: May 12, 2005

(54) Panel display

(75) Inventors: Rong-Wha Wu, Yunlin (TW); Pei-Chang Li, Taoyuan (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/970,573

(22) Filed: Oct. 21, 2004

(30) Foreign Application Priority Data
Oct. 22, 2003 (TW) TW92129232

(51) Int. Cl. G09G 5/00

(52) U.S. Cl. 345/156

(57) ABSTRACT

A panel display. The panel display comprises a control pad and a receiving portion. The control pad is detachably connected to the panel display. Furthermore, the control pad transmits a signal to the panel display. The receiving portion is disposed on the panel display to receive the control pad.

### BACKGROUND OF THE INVENTION

1. Field of the Invention

The present invention relates in general to a panel display, and more particularly, to a panel display having a control pad detachably connected thereto.

2. Description of the Related Art

Generally, the conventional panel display is provided with several control buttons located on the housing of the panel display. As shown in FIG. 1, the conventional panel display 10 has a main body 101, a base 105 and a panel 102. Moreover, several control buttons 103 and an indicator 104 are disposed below the panel 102. The indicator 104 shows status of the display, and the display settings are modified via the control buttons 103.

To make the panel display lighter, thinner and more compact, the width of the border of the main body 101 must be minimized.

### SUMMARY OF THE INVENTION

Accordingly, an object of the present invention is to provide a panel display having a control pad detachably connected thereto. The panel display comprises a control pad and a receiving portion. The control pad is detachably connected to the panel display. Furthermore, the control pad transmits an electromagnetic signal to the panel display. The receiving portion is disposed on the panel display to receive the control pad.

### DESCRIPTION OF THE DRAWINGS

The present invention will become more fully understood from the detailed description given hereinbelow and the accompanying drawings, given by way of illustration only and thus not intended to be limitative of the present invention.

FIG. 1 is a perspective diagram of a conventional panel display.

FIG. 2 is a perspective diagram in accordance with the first embodiment of the present invention.

FIG. 3 is a perspective diagram of the control pad in accordance with the present invention.

FIG. 4a is a perspective diagram showing the receiving portion in accordance with the present invention.

FIG. 4b is an enlarged view of the receiving portion in accordance with FIG. 4a.

FIG. 5 is a perspective diagram in accordance with the second embodiment of the present invention.

FIG. 6 is a perspective diagram in accordance with the third embodiment of the present invention.

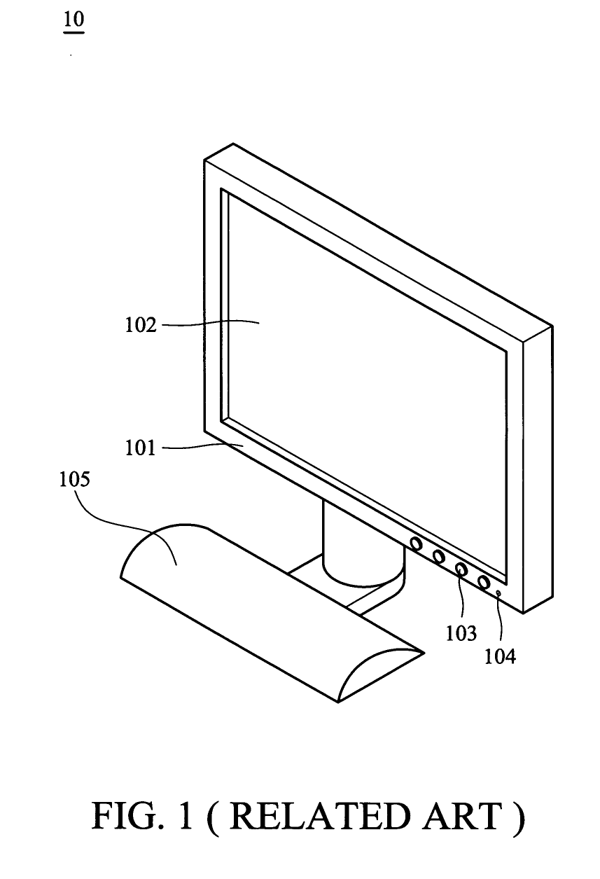

### DETAILED DESCRIPTION OF THE INVENTION

### FIRST EMBODIMENT

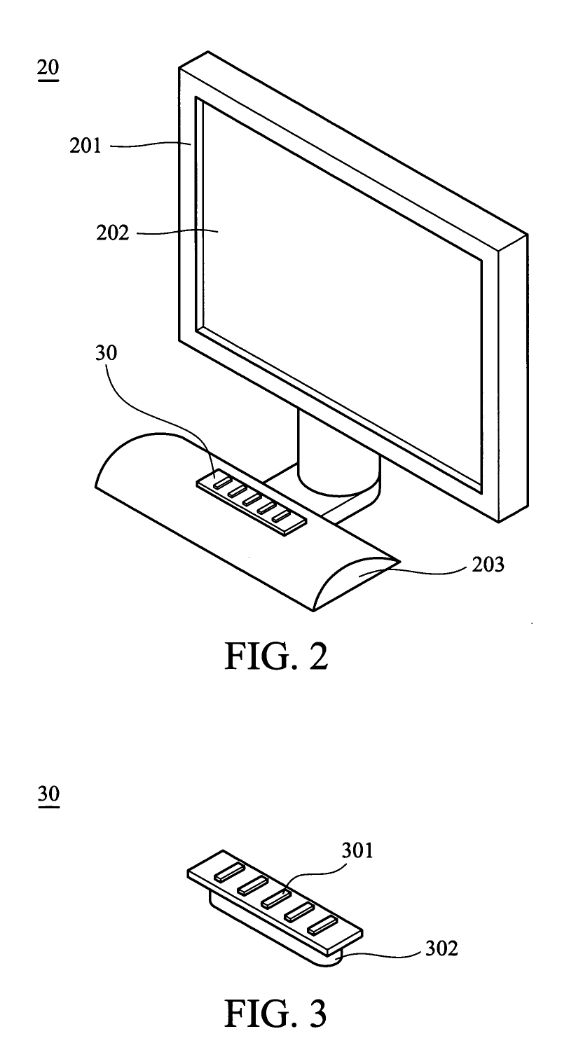

An object of the present invention is to provide a panel display having a control pad detachably connected thereto. Referring to FIG. 2, the panel display 20 comprises a main body 201, a base 203 and a control pad 30. A panel 202 is disposed on the main body 201. The base 203 is connected to and supports the main body 201. The control pad 30 is disposed on the base 203 and transmits a radio OSD signal to the panel display to modify the display settings.

In the present embodiment, the control pad 30 is detachably connected to the base 203. When the control pad 30 is separated from the base 203, it serves as a remote control device transmitting an OSD signal to the panel display 20. Furthermore, as shown in FIG. 3, the control pad 30 is provided with several buttons 301 thereon. Moreover, the control pad 30 has a protrusion 302 for connecting the base 203.

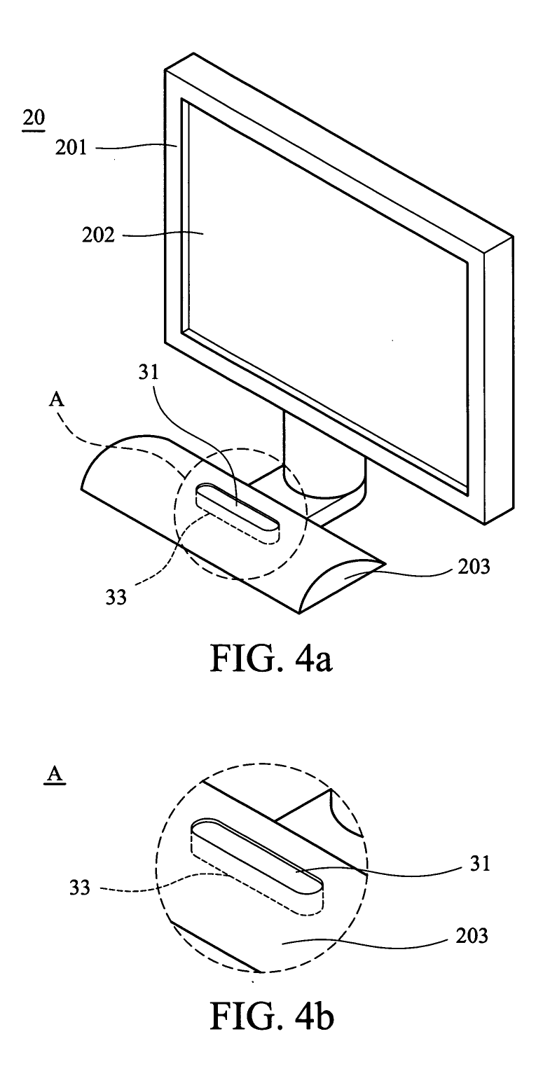

As shown in FIG. 4a and FIG. 4b, the base stand 203 is provided with a receiving portion 33 and a cover 31 disposed therein. The receiving portion 33 is a recess matching the protrusion 302. Thus, the protrusion 302 can be properly inserted into the receiving portion 33.

Specifically, the cover 31 is disposed in the receiving portion 33 and connected to an elastic member inside the base 203 such as a spring (not shown). Thus, the protrusion 302 can be inserted into the receiving portion 33 by pushing the cover 31 downward such that the control pad 30 is connected to the base 203. When the control pad 30 is separated from the base 203, however, the elastic member exerts a spring force pushing the cover 31 upward to form an integral surface.

### SECOND EMBODIMENT

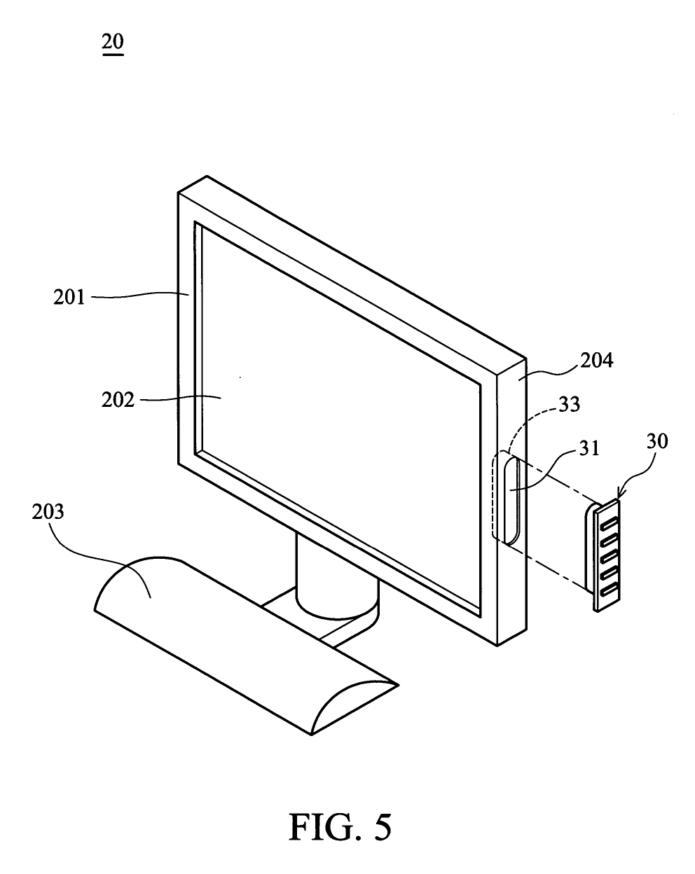

Referring to FIG. 5, the control pad 30 is detachably connected to the panel display on the lateral surface 204 of the main body 201. In this embodiment, the main body 201 has a lateral surface 204 and a receiving portion 33 disposed thereon to receive the control pad 30. The receiving portion 33 is a recess matching the control pad 30 such that the control pad 30 can be inserted therein. Specifically, the cover 31 is disposed in the receiving portion 33 and connected to an elastic member inside the base 203 such as a spring (not shown). As mentioned above, when the control pad 30 is separated, the elastic member exerts a spring force pushing the cover 31 upward to form an integral surface with lateral surface 204. Moreover, external objects can also be presented from falling into the receiving portion 33.

### THIRD EMBODIMENT

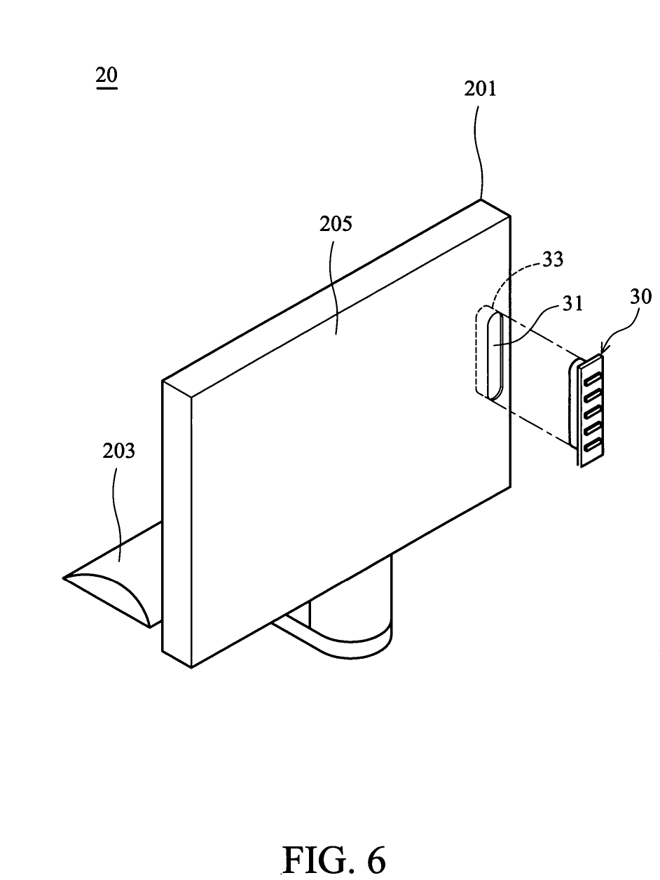

As shown in FIG. 6, the control pad 30 is detachably connected to the panel display on the rear surface 205. In this embodiment, the main body 201 has a rear surface 205 and a receiving portion 33 disposed therein to receive the control pad 30. The receiving portion 33 is a recess matching the control pad 30. As mentioned above, the cover 31 and an elastic member (not shown) are disposed in the receiving portion 33. The spring exerts a force pushing the cover 31 upward to form an integral surface when the control pad 30 is removed. Moreover, external objects can also be presented from falling into the receiving portion 33.

In summary, the present invention provides a panel display having a detachable control pad 30. The control pad 30 can transmit an OSD signal to modify display settings. Moreover, the panel display is provided with a receiving portion 33 to receive the control pad 30, wherein the receiving portion 33 can be disposed on the base 203 or the main body 201 of the panel display. According to the present invention, the conventional control buttons on the display surface can be removed such that the border width and size of the main body 201 can be reduced. This is particularly convenient for wall-mounted panel displays without base. Moreover, remote control of display settings via control pad 30 is more convenient than in the related art.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation to encompass all such modifications and similar arrangements.

1. A panel display, comprising:
a control pad detachably connected to the panel display; and
a receiving portion disposed on the panel display to receive the control pad, wherein the control pad transmits an electromagnetic signal to the panel display.

2. The panel display as claimed in claim 1 further comprising a cover disposed in the receiving portion.

3. The panel display as claimed in claim 2 further comprising an elastic member connecting the cover, wherein the elastic member exerts a spring force pushing the cover upward to form an integral surface with the panel display when the control pad is detached.

4. The panel display as claimed in claim 3 further comprising a main body with the receiving portion disposed thereon.

5. The panel display as claimed in claim 3 further comprising a base with the receiving portion disposed thereon.

6. The panel display as claimed in claim 3, wherein the elastic member is disposed in the receiving portion.

7. The panel display as claimed in claim 2, wherein the receiving portion is a recess.

8. The panel display as claimed in claim 1, wherein the control pad comprises at least a control button disposed thereon.

9. The panel display as claimed in claim 1, wherein the electromagnetic signal comprises a radio OSD signal, and the control pad transmits the radio OSD signal to the panel display.

10. The panel display as claimed in claim 1, wherein the control pad has a protrusion which locates in the receiving portion when the control pad is connected to the panel display.

11. The panel display as claimed in claim 10, wherein the size of the protrusion is equal to that of the receiving portion.

12. A panel display, comprising:
a control pad detachably connected to the panel display and transmitting an electromagnetic signal thereto;
a receiving portion disposed on the panel display to receive the control pad;
a cover disposed in the receiving portion; and
an elastic member connecting the cover and exerting a spring force pushing the cover upward to form an integral surface of the panel display when the control-pad is detached.

13. The panel display as claimed in claim 12 further comprising a main body with the receiving portion disposed thereon.

14. The panel display as claimed in claim 13, wherein the main body comprises a lateral surface with the receiving portion disposed thereon.

15. The panel display as claimed in claim 13, wherein the main body comprises a rear surface with the receiving portion disposed thereon.

16. The panel display as claimed in claim 12 further comprising a base with the receiving portion disposed therein.

17. The panel display as claimed in claim 12, wherein the elastic member is disposed in the receiving portion.

18. The panel display as claimed in claim 3, wherein the electromagnetic signal comprises a radio OSD signal, the control pad transmits the radio OSD signal to the panel display.
